(19) United States
(12) Patent Application Publication
(10) Pub. No.: US 2009/0227273 A1
(43) Pub. Date: Sep. 10, 2009

(54) SPLIT ANALOG-DIGITAL RADIO SYSTEMS AND METHODS

(75) Inventor: Earl W. McCune, JR., Santa Clara, CA (US)

Correspondence Address: SNELL & WILMER L.L.P. (Panasonic), 600 ANTON BOULEVARD, SUITE 1400, COSTA MESA, CA, 92626, US

(73) Assignee: Matsushita Electric Industrial Co., Ltd.

(21) Appl. No.: 12/043,839

(22) Filed: Mar. 6, 2008

(51) Int. Cl. H04Q 7/22

(52) U.S. Cl. 455/466

(57) ABSTRACT

A radio system includes a baseband integrated circuit and a radio frequency module partitioned along an analog-digital boundary. The baseband integrated circuit is configured to generate modulation signals from a digital message. The radio frequency module includes a controlled oscillator, a radio frequency upconverter and a power amplifier. The controlled oscillator is configured to generate a radio frequency transmit carrier signal. The radio frequency upconverter is configured to generate radio frequency modulated signals from the radio frequency transmit carrier signal and information contained in the modulation signals received from the baseband integrated circuit. Finally, the power amplifier is configured to amplify the radio frequency modulated signals so that the resulting amplified radio frequency modulated signals are suitable for being radiated over the air to a remote receiver.

### FIELD OF THE INVENTION

The present invention relates to radio systems. More specifically, the present invention relates to radio systems and methods that are partitioned along analog-digital boundaries.

### BACKGROUND OF THE INVENTION

A radio system is the central constituent of any radio frequency (RF) wireless communications system. FIG. 1 is a drawing of a typical radio system 100. The radio system 100 comprises a baseband processor 102; a transmitter portion that includes an upconverter mixer 104, transmit voltage controlled oscillator (TXVCO) 106 and power amplifier (PA) 108; a receiver portion that includes a low-noise amplifier (LNA) 110, downconverter mixer 112 and receive voltage controlled oscillator (RXVCO) 114; a transmit/receive switch 116; and an antenna 118.

During times when the radio system 100 is configured to transmit, the transmit/receive switch 116 is connected to the output of the PA 108. In preparation for transmission the baseband processor 102 operates to group bits of an incoming digital message into a sequence of multi-bit symbols, and, based on the grouping of bits, generate baseband modulation signals having various predetermined amplitude, frequency and/or phase modulation states defined by an applicable digital modulation scheme. The baseband modulation signals are coupled to the upconverter mixer 104, which operates to mix the baseband modulation signals with an RF transmit carrier signal from the TXVCO 106, thereby generating a modulated RF transmit carrier signal. The modulated RF transmit carrier signal is amplified by the PA 108 and radiated by the antenna 118 to a remote receiver (not shown in the drawing).

During times when the radio system 100 is configured to receive, the transmit/receive switch 116 is connected to the input of the LNA 110. The antenna 118 receives an RF receive carrier that is modulated by a digital message received from a remote transmitter (not shown in the drawing). The RF LNA 110 amplifies the modulated RF receive carrier signal. The downconverter mixer 112 downconverts the amplified RF receive carrier signal using an RF signal generated by a receive voltage controlled oscillator (RXVCO) 114 of the same RF frequency, thereby generating a received baseband signal. Finally, the baseband processor 102 processes the received baseband signal to extract the received digital message.

Most modern radio systems are constructed using several integrated circuit (IC) chips. IC chips are compact, provide high speed, have low power dissipation, and are cost effective when mass produced. These qualities are particularly beneficial in applications where the radio system is used in a portable wireless communications device such as, for example, a cellular handset.

FIG. 2 is a drawing of a typical state-of-the-art radio system 200 constructed of several IC chips. The radio system 200 comprises a baseband IC 202, a radio frequency IC (RFIC) 204, a PA module 206, filters and switch 208, and an antenna 210. The baseband IC 202 includes a baseband processor 212 that generates baseband modulation signals. The RFIC 204 is a “mixed signal” IC chip, meaning that it includes both analog and digital circuitry. It comprises a radio transceiver 214 that includes the RF circuitry necessary to upconvert the baseband modulation signals from the baseband IC 202 to RF, and the receiver front end, which includes the amplifying and downconversion circuitry needed to amplify and downconvert the modulated RF receive carrier signal received from the remote transmitter. If, for example, the radio system of FIG. 1 were implemented using IC chips, the receiver front end circuit elements, including the downconverter mixer 112, RXVCO 114 and LNA 110, as well as the upconverter mixer 104 and TXVCO 106, would be typically included as part of the radio transceiver 214 on the RFIC 204.

The radio system's PA 218 is part of the transmitter front end, and is also technically considered a component of the system's radio transceiver. However, for reasons that will be discussed below, the PA 218 is not formed with other parts of the front end in the RFIC 204. Instead, it is included in a separate PA module 206.

The radio system 200 in FIG. 2 is comprised of several IC chips and represents the state-of-the art in radio system technology. Nevertheless, various attempts have been made over the years to develop an entire radio system on a single integrated circuit chip. These efforts have been fueled by successes in the microprocessor industry in which commercially viable computer systems on a chip have been demonstrated, designed and produced. While a limited degree of success in forming a single-chip solution has also been demonstrated in low power radio applications such as, for example, Bluetooth radio systems, those successes have not extended to higher power radio systems, such as those used in cellular handsets, for example.

The primary function of the PA in a radio system is to generate electromagnetic fields that the radio system's antenna can radiate to a remote receiver. The required strength of these electromagnetic fields is particularly high in radio systems that are employed in cellular handsets, due to the large distances that typically separate the cellular handsets from the system basestations. For example, compared to the PA in a low power application like Bluetooth, which employs a PA that transmits at a power of 5 dBm (or 3 mW) or less, the transmit power of the PA in a cellular handset is typically within the range of 30-33 dBm (or 1 to 3 Watts). This large disparity in transmit powers follows from the fact that in low power applications, the radio system's PA and remote receiver are, at the most, only several meters apart, while in cellular applications the radio system's PA and remote receiver are typically thousands of meters apart. The much larger separation in the case of cellular applications obviously requires much larger transmission powers.

At large output power levels, if the radio system's TXVCO is placed too close to the PA the electromagnetic fields radiated by the radio system's antenna feed back and interfere with the inductive field generated by the TXVCO. This “radiated field feedback” phenomenon, which is conceptually illustrated in FIG. 3, is highly undesirable since it adversely affects the intended operating frequency of the TXVCO, and can even render the VCO 112 unstable or inoperable. Moreover, substantial amounts of in-band signal distortion and adjacent channel power leakage occur if the TXVCO and PA are positioned too close to one another, thereby making it difficult or impossible for the radio system to comply with applicable wireless standards specifications. It is for these reasons that the PA used in radio systems of cellular handsets (and other higher power wireless communications devices) is neither co-located with (e.g., not on the same module) nor included on the same IC as the TXVCO.

Companies in the business of designing state-of-the art radio systems acknowledge the problems associated with co-locating the TXVCO and PA and, in so doing, take special precautions to avoid co-locating them. Nevertheless, they continue to seek alternative ways of reducing the size and cost of radio systems. One approach that is currently being pursued involves attempting to move RF components traditionally formed on the RFIC (e.g., mixers, VCOs and LNAs) onto the baseband IC. Unfortunately, this approach has a number of drawbacks.

First, companies that are proficient in digital circuit design usually lack the technical know-how and experience necessary to design and integrate RF circuitry with digital circuitry in the baseband IC. RF circuit design and digital circuit design are very different disciplines and have very different design methodologies and design goals. Consequently, any effort that is undertaken to co-integrate RF and digital circuitry usually has a limited probability of success and, at the very least, is burdened with large nonrecurring engineering costs.

Second, even if the requisite expertise were to be available, the all-digital fabrication process used to fabricate the baseband IC (typically a complementary metal-oxide-semiconductor (CMOS) logic process) must be modified in order to accommodate the analog RF components. Efforts to avoid having to modify the all-digital processes have been made by attempting to design digital equivalents for the analog RF components being moved onto the RFIC. However, since not all analog RF components and circuit elements (e.g., the TXVCO and LNA) are capable of being redesigned into all-digital equivalents, the only alternative under this approach is to modify the all-digital fabrication process so that the baseband IC can accommodate both the digital and analog components. Unfortunately, for the reasons discussed below, modifying the all-digital fabrication process to accommodate analog RF components has various significant and undesirable consequences.

All-digital fabrications processes like CMOS logic processes are generally characterized by their very high yields. However, these high yields are substantially compromised when large-area components (like the radio system's TXVCO and LNA, for example) are moved onto the baseband IC. VCOs include large spiraled inductors that consume a large area of the baseband IC. Their large areas of occupation increases the probability of yield losses. Analog RF circuitry performance is also much more sensitive to manufacturing processing fluctuations than is digital circuitry. This sensitivity also contributes to reduced yields compared to an all-digital approach.

Yield problems are exacerbated even further, as scaling methods are applied in attempts to further reduce the size and power requirements of a baseband IC containing both analog and digital components. Digital circuitry is amenable to being scaled. However, for the most part, analog circuitry is not. Consequently, as the digital circuitry in a mixed analog-digital baseband IC is scaled, the probability of a defective chip or wafer increases simply by virtue of the fact that the analog components end up occupying a higher percentage of the scaled IC chip than they do in an un-scaled chip.

Moving analog components traditionally formed on the RFIC onto the baseband IC also increases production costs, even when increased costs due to reduced yields are not factored in. These increased costs relate to the large areas that the analog components typically occupy in an IC chip. In addition to the large chip areas occupied by the TXVCO's spiraled inductor, a large-area buffer zone must be formed around the TXVCO in order to prevent other circuitry on the baseband IC from interfering with the TXVCO's inductive field. Similarly, if the radio system's LNA and other front end components are moved onto the baseband IC, a large buffer zone must also be formed around the LNA, in order to shield it from interference caused by other circuitry on the baseband IC. The added analog components and their associated buffer zones result in a significantly larger baseband IC chip compared to a baseband IC chip not having the added analog components and buffer zones. Unfortunately, a larger baseband IC chip translates into a fewer number of realizable dice per wafer, significantly higher material costs and other increased production costs.

Given the foregoing problems and limitations of prior art radio systems, it would be desirable to have radio systems and methods that derive benefits from having a reduced number of IC chips, yet which also avoid the yield, cost and performance problems associated with existing prior art radio system approaches.

### BRIEF SUMMARY OF THE INVENTION

Radio systems and methods that are partitioned along analog-digital boundaries are disclosed. An exemplary radio system includes a baseband integrated circuit (BB IC) and a radio frequency (RF) module. The BB IC is configured to generate modulation signals from a digital message. The RF module includes a controlled oscillator, an RF upconverter and a power amplifier (PA). The controlled oscillator is configured to generate an RF transmit carrier signal. The RF upconverter is configured to generate RF modulated signals from the RF transmit carrier signal and information contained in the modulation signals received from the BB IC. Finally, the PA is configured to amplify the RF modulated signals so that the resulting amplified RF modulated signals are suitable for being radiated over the air to a remote receiver.

An exemplary method of generating an RF modulated signal in a radio system that has a BB IC and an RF module includes first, generating information bearing digital modulation signals on the BB IC and converting the information bearing digital modulation signals to information bearing analog modulation signals. The information bearing analog modulation signals are then upconverted to RF to generate RF modulated signals, and amplified to generate amplified RF modulated signals. Upconverting the information bearing analog modulation signals and amplifying the RF modulated signals are both performed on the RF module. Finally, the amplified RF modulated signals are radiated over the air to a remote receiver.

According to one aspect of the invention, the BB IC comprises an all-digital IC, i.e., an IC containing only digital circuitry. The all-digital BB IC is separated from analog and RF components on the RF module by an all-digital interface. Unlike prior art approaches that combine analog and digital circuitry in the baseband IC and/or in a separate RFIC, the all-digital BB IC used in the various embodiments of the present invention is smaller, can be fabricated using high-yield digital semiconductor manufacturing processes such as, for example, the complementary metal-oxide-semiconductor (CMOS) logic process, and is amenable to scaling processes.

According to another aspect of the invention, the controlled oscillator used to generate the RF transmit carrier signal for the radio system's RF upconverter comprises a low-field oscillator (LFO). Use of an LFO allows the LFO and PA of the radio system to be co-located with other analog and RF circuitry on the RF module, even in high power applications such as, for example, cellular handset applications. Inclusion of the LFO, PA and other analog and RF components on a common RF module obviates any need for a separate mixed-signal RFIC.

Those of ordinary skill in the art will readily appreciate and understand, based on a reading of this disclosure, that the methods and systems of the present invention are not limited to any particular type of radio system architecture. For example, they are applicable in either homodyne or superheterodyne radio system architectures, and may be incorporated into either quadrature-based or non-quadrature based (e.g., polar modulator based) architectures.

Other objects, features and advantages of the present invention will become apparent upon consideration of the following detailed description of the invention and the accompanying drawings.

### BRIEF DESCRIPTION OF THE DRAWINGS

FIG. 1 is a drawing of a typical radio system;

FIG. 2 is a drawing of a typical state-of-the-art radio system comprised of a baseband integrated circuit (IC), a mixed signal radio frequency integrated circuit (RFIC) and a power amplifier (PA) module;

FIG. 3 is a drawing illustrating how an electromagnetic field generated by a prior art radio system's PA is undesirably fed back to the radio system's voltage controlled oscillator (VCO) when the PA and VCO are co-located;

FIG. 4 is a drawing of a split analog-digital radio system, according to an embodiment of the present invention;

FIG. 5 is a drawing of a low-field oscillator (LFO), which may be used to implement the controlled oscillator of the radio system in FIG. 4, and which may be used to implement the controlled oscillators of other radio systems of the present invention;

FIG. 6 is a drawing of another type of LFO, which may be used to implement the controlled oscillator of the radio system in FIG. 4, and which may be used to implement the controlled oscillators of other radio systems of the present invention;

FIG. 7 is a drawing of a split analog-digital quadrature-based radio system, according to an embodiment of the present invention; and

FIG. 8 is a drawing of a split analog-digital polar modulator based radio system, according to an embodiment of the present invention.

### DETAILED DESCRIPTION

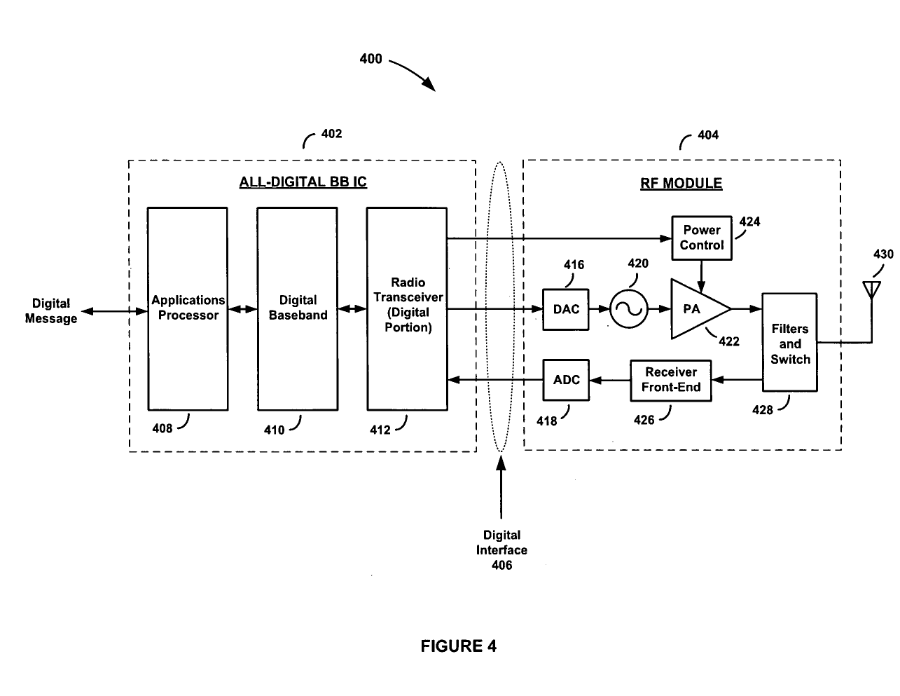

Referring to FIG. 4, there is shown a split analog-digital radio system 400, according to an embodiment of the present invention. The split analog-digital radio system 400 comprises an all-digital baseband integrated circuit (BB IC) chip 402, a radio frequency (RF) module 404 and an antenna 430. Data and control signals between the BB IC 402 and RF module 404 are communicated via an all-digital interface 406.

The all-digital BB IC 402 comprises an applications processor 408, a digital baseband processor 410, and digital portion 412 of the radio system's radio transceiver (e.g., digital portions of the transceiver's upconversion and downconversion circuitry). The applications processor 408 performs various functions, including call processing, gaming, multimedia and other entertainment processing functions. Depending on the application, it may also be configured to provide processing functions for other user-related features such as, for example, calculator, personal digital assistant, note pad, and address book functions. The digital baseband processor 410 comprises a digital signal processor (DSP) and a central processing unit (CPU), for generating digital baseband modulation signals having modulation states defined by an applicable wireless communications standard (e.g., the Global System for Mobile Communications (GSM) standard or the Wideband Code Division Multiple Access (W-CDMA) standard), and for performing other digital signal processing functions and calculations necessary for the operation of the radio system 400. Although shown as separate processors in FIG. 4, in an alternative embodiment, the DSP and CPU of the digital baseband processor 410 are configured to perform the applications processing functions, in addition to the other digital signal processing functions performed by the DSP and CPU.

As will be explained in more detail below, the all-digital BB IC 402 further includes interface logic that allows digital control and data signals to be communicated between the BB IC 402 and the RF module 404. It may also include digital baseband modulation and demodulation circuitry, digital portions of a frequency control loop used to lock the controlled oscillator 420 on the RF module 404 to a desired transmit frequency, timing control circuitry for providing temporal alignment of signals communicated on different paths between the BB IC 402 and the RF module 404, and other digital portions of mixed analog/digital circuits formed partially on both the all-digital BB IC 402 and the RF module 404.

The RF module 404 comprises one or more substrates (e.g., one or more printed circuit boards) onto which the baseband analog and RF analog components of the radio system 400 are mounted. As shown in FIG. 4, the baseband analog and RF analog components include a controlled oscillator 420, a power amplifier (PA) 422, a power control circuit 424, the analog portion of a receiver front end 426, and filters and switch 428. The controlled oscillator 420 is used to upconvert baseband modulation signals received from the BB IC 402 to RF. The PA 422 operates to amplify the upconverted signals. The power control circuit 424 is a digitally controlled circuit that operates to control the output power of the PA 422, based on digital control signals received from the BB IC 402. The filters and switch 428 includes analog filters (e.g., band-pass filters and low-pass filters) and a switch (for half duplex operation) or duplexer (for full duplex operation). The receiver front end 426 includes a low-noise amplifier (LNA) and analog portions of the radio system's downconversion circuitry.

The RF module 404 is mostly-all analog, and includes only a limited number of digital circuits. This limited number of digital circuits includes digital portions of the DAC 416 and ADC 418 circuitry, which is needed to convert digital signals from the BB IC 402 into analog signals for the RF module 404 and analog signals on the RF module 404 to digital signals for the BB IC 402. The DAC 416 and 418 circuitry also allows communications between the BB IC 402 and the RF module 404 to be conducted over an all-digital interface 406.

Partitioning the radio system 400 along a digital-analog boundary provides a number of advantages over prior art radio system designs. First, by moving all of the baseband analog and RF analog components of the radio system 400 onto the RF module 404 and most all of the digital components of the system 400 onto the all-digital BB IC 402, there is no need for a separate RFIC or any need to form a BB IC having mixed analog and digital functions. Second, because the digital-analog partitioning results in an all-digital BB IC 402, the all-digital BB IC 402 can be manufactured using standard high-yield digital semiconductor manufacturing processes such as, for example, the complementary metal-oxide-semiconductor (CMOS) logic process. Third, because the all-digital BB IC 402 does not include the radio system's TXVCO, buffer zone, or other baseband analog or RF analog circuitry, it is substantially smaller in size compared to prior art mixed signal BB ICs. Finally, the BB IC 402 is amenable to scaling, since yield problems associated with scaling mixed signal ICs is avoided by the all-digital BB IC 402 implementation.

According to one aspect of the invention, the controlled oscillator 420 in the radio system 400 may be implemented using an oscillator type that is inherently less susceptible to radiated field feedback from the PA 422 than VCOs that employ coils or spiraled inductors. For example, in some cellular communications applications in which the PA of a cellular handset must transmit at relatively large output powers (e.g., greater than about 1 Watt), the controlled oscillator 420 may be implemented using a “low-field” type of controlled oscillator. To distinguish low-field types of oscillators from prior art controlled oscillators that employ coils or spiraled inductors, the term “VCO” is used herein to refer to the latter. The term “LFO,” which stands for “low-field oscillator,” is used herein to refer to oscillator types that are inductor-less and coil-less and which generate comparatively lower fields. The low-field attribute of the LFO, which may be voltage controlled despite the difference in terminology between it and the contrasting term VCO, allows the controlled oscillator 420 to be either co-located on the same RF module 404 as the PA 422 or formed in the same integrated circuit chip as the PA 422, even in applications in which relatively large fields are generated by the radio system's PA 422. Performance problems caused by radiated field feedback from the PA 422 to the controlled oscillator 420 are, therefore, substantially reduced.

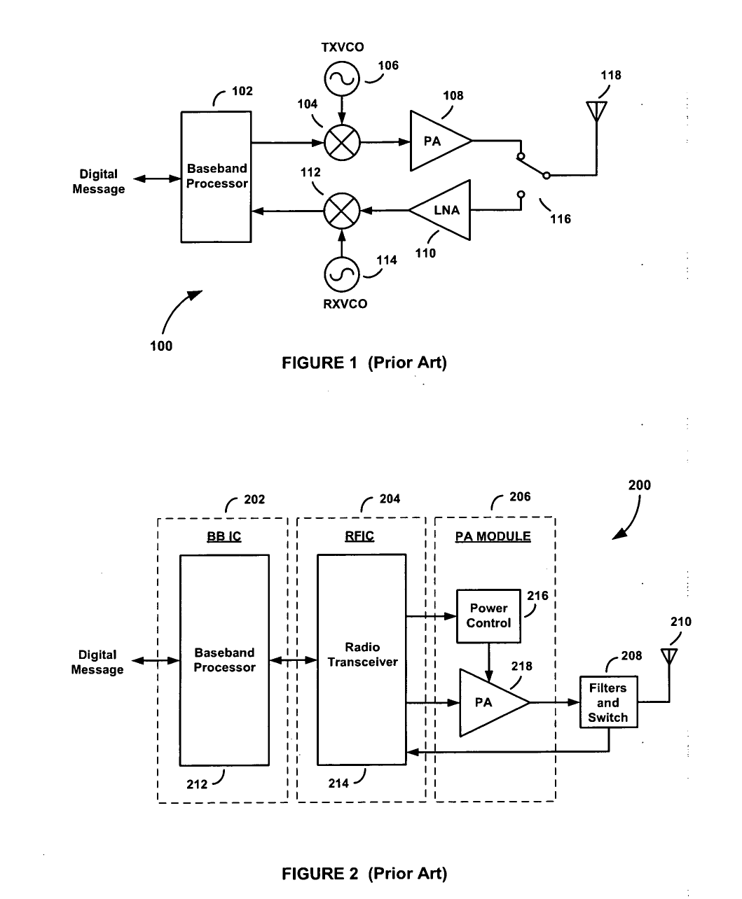

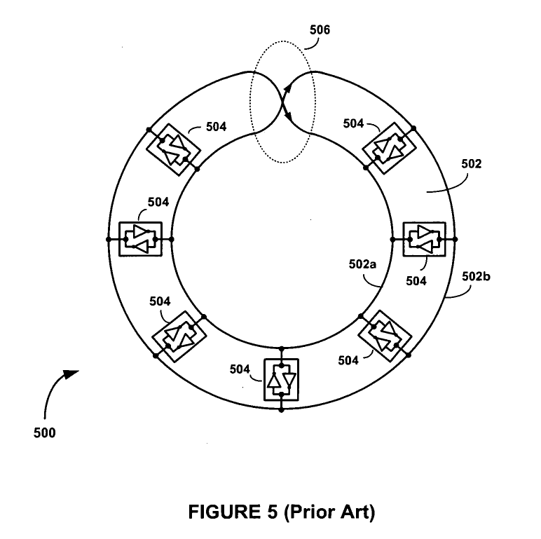

FIG. 5 is a drawing of an LFO 500 known in the art which may be used to implement the controlled oscillator 420 of the radio system 400 in FIG. 4, and which may be used to implement the controlled oscillators of other radio systems of the present invention described below. The LFO 500 comprises a closed-loop transmission line 502, comprised of first and second conjoined conductive loop traces 502a and 502b configured as a planarized differential Moebius strip, and a plurality of bidirectional, regenerative/amplifying circuits 504 distributed between and along the conductive loop traces 502a and 502b. The Moebius-strip-like transmission line 502 is made by forming a half-twist 506 along the length of an open-ended strip and then joining the ends of the strip to form a closed loop. In effect, the half-twist 506 converts the two-dimensional strip, with its two opposing surfaces and two opposing edges, into a strip having only a single surface and a single edge. The field distribution along the Moebius-strip-like transmission line 502 is significantly constrained compared with conventional coiled or spiraled inductor VCOs used in prior art systems, like the one shown in FIG. 1 above. Further details of LFOs similar to that shown and described in FIG. 5 are described in U.S. Pat. No. 6,525,618 to Wood, which is hereby incorporated into this disclosure by reference.

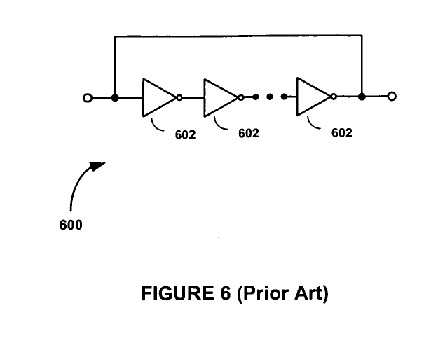

FIG. 6 is a drawing of another type of LFO 600, known as a “ring oscillator,” which can be alternatively used to implement the LFOs of the various embodiments of the present invention. The ring oscillator 600 is generally comprised of an odd number of inverters 602 connected in series, with the output of the last inverter being fed back to the input of the first inverter. The feedback of the output of the last inverter to the input of the first inverter causes oscillation. Similar to the LFO 500 in FIG. 5, the LFO 600 in FIG. 6 generates an electromagnetic field that is substantially lower in strength and more spatially contained than the electromagnetic fields radiated by conventional VCO structures. For these reasons, the LFO 600 can be formed in the same integrated circuit chip as the PA, without the radio system suffering from field feedback performance problems as would be observed in a radio system having a PA co-located with a conventional VCO. Further details of the LFO 600, and other types of controlled oscillators that may be used to implement the LFOs in the various embodiments of the present invention, are described in U.S. Pat. No. 6,686,806 to Dufour, which is hereby incorporated into this disclosure by reference.

Further details of the LFOs 500 and 600 in FIGS. 5 and 6, and other techniques that may be used to reduce the effects of radiated field feedback in the radio systems of the present invention are described in co-pending and commonly assigned U.S. patent application Ser. No. 11/867,945, entitled “Methods and Apparatus for Reducing Radiated Field Feedback in Radio Frequency Transmitters,” which was filed on Oct. 5, 2007, and which is hereby incorporated by reference in its entirety.

The radio systems and methods of the present invention, particularly when configured to use an LFO for the radio system's transmit controlled oscillator, are particularly well suited for use in cellular communications devices (e.g., cellular handsets) that are configured for use in cellular communications systems. The low susceptibility to radiated field feedback, even at relatively high transmit powers, allows the LFO to be co-located with the PA on the same RF module. This ability to co-locate the LFO and PA obviates the need to form the controlled oscillator on a separate IC or module. While the radio systems and methods of the present invention are well suited for cellular communications devices, those of ordinary skill in the art will appreciate and understand that the inventions are not limited to only those types of applications.

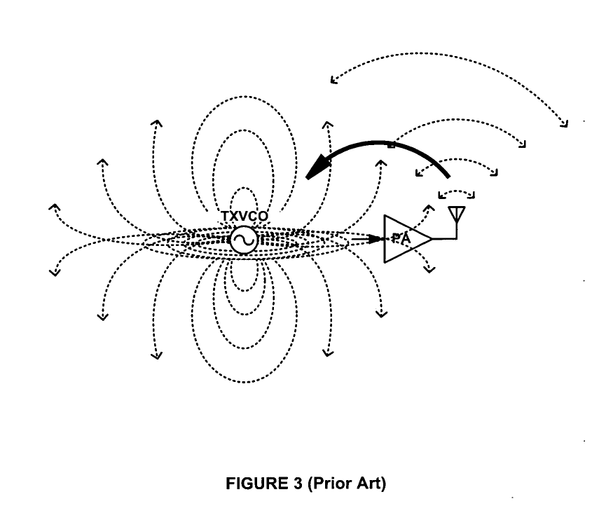

As discussed above, the RF module 404 of the radio system 400 in FIG. 3 comprises one or more substrates (e.g., one or more printed circuit boards) onto which the baseband analog and RF analog components of the radio system 400 are mounted. The various baseband analog and RF analog components of the radio system 400 in FIG. 4 are mounted on the one or more substrates in the form of one or more IC chips, in the form of discrete components, or a combination of discrete components and IC chips. The PA 422 may be silicon-based or may be manufactured from a compound semiconductor such as, for example, gallium-arsenide (GaAs). The controlled oscillator 420 may also be either silicon-based or compound-semiconductor-based. If made from the same type of semiconductor as the PA 422, the controlled oscillator 420 and PA 422 can both be formed in the same IC chip. Whether formed in a common IC chip, in separate IC chips, or as a combination of discrete and integrated components, the PA 422 and controlled oscillator 420 can be co-located on the RF module 404, and without the undesirable effects of radiated field feedback, by using an LFO to implement the controlled oscillator 420. According to one embodiment of the invention, the controlled oscillator 420 is implemented as an LFO and is included within a silicon-based IC mounted on the RF module 404, and the PA 422 comprises a compound semiconductor based IC co-located with the LFO on the RF module 404. The IC containing the LFO and the IC containing the PA are mounted on the module 404 and are co-located (e.g., less than a centimeter apart).

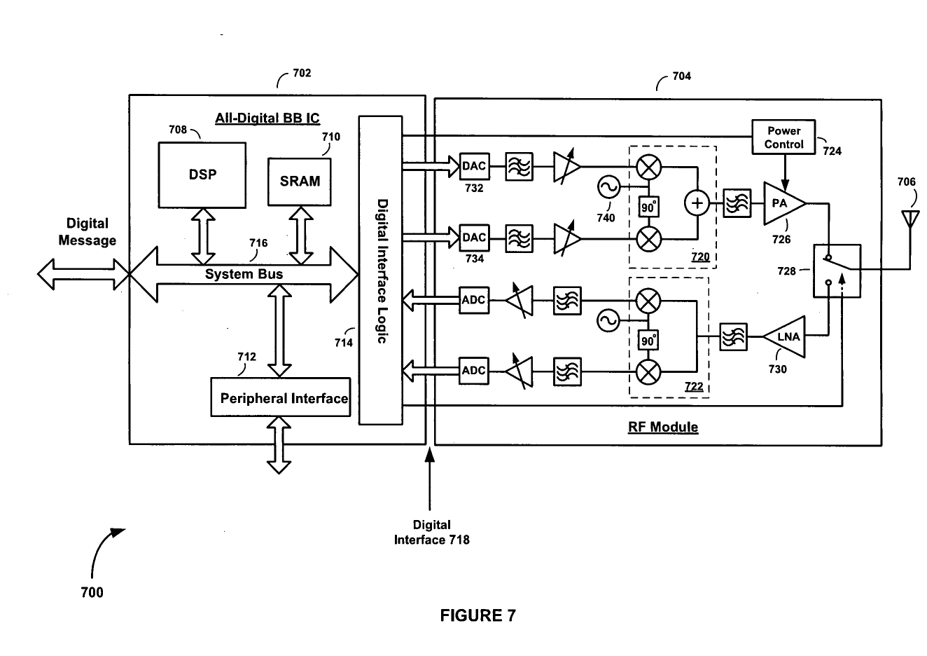

The present invention is not limited to any particular type of radio system architecture. FIG. 7 illustrates, for example, a direct conversion quadrature-based radio system 700 partitioned along a digital-analog boundary, according to an embodiment of the present invention. Similar to the radio system 400 in FIG. 4, the radio system 700 in FIG. 7 comprises an all-digital BB IC 702, a mostly-all analog RF module 704, and an antenna 706.

The all-digital BB IC 702 includes, among other digital components, a DSP 708, static random access memory (SRAM) 710, a peripheral interface 712, and digital interface logic 714, all of which are coupled to a system bus 716. The DSP 708 is operable to generate baseband modulation signals for the RF module 704 from a digital message received on the system bus 716. This process includes grouping digital bits of the incoming digital message into digital symbols in accordance with an applicable digital modulation scheme, converting the digital symbols into in-phase (I) and quadrature phase (Q) sequences of symbols, and pulse-shaping the I and Q sequences of symbols to provide the desired digital I and Q baseband modulation signals. The DSP 708 includes a CPU for executing processing instructions loaded into the SRAM 710 from an external non-volatile memory device such as, for example, a Flash memory device, via the peripheral interface 712. Once generated, the I and Q digital baseband modulation signals are sent over the system bus 716 to the RF module 704, via the digital interface 718.

The RF module 704 includes the baseband analog and RF analog components of the radio system 700. The primary components on the RF module 704 include an RF upconverter 720, an RF downconverter 722, a power control circuit 724, a PA 726, a transmit/receive switch 728, and an LNA 730.

When the radio system 700 is configured to transmit, the transmit/receive switch 728 is in a position that connects the antenna 706 to the output of the PA 726. In preparation for transmission, the I and Q digital baseband modulation signals are coupled to first and second DACs 732 and 734. The first and second DACs 732 and 734 convert the I and Q digital baseband modulation signals into I and Q analog baseband modulation signals. The I and Q analog baseband modulation signals are low-pass filtered to suppress adjacent channel emission levels and to eliminate aliasing products, and amplified. The filtered and amplified I and Q analog baseband modulation signals are then upconverted to RF by the RF upconverter 720, thereby generating an RF modulated signal at the output of the RF upconverter 720. According to an embodiment of the invention, the controlled oscillator 740 used to provide the RF carrier signal to the RF upconverter 720 comprises an LFO similar to that described above in FIGS. 5 and 6. Use of an LFO affords the ability to co-locate the oscillator 740 and the PA 726 on the RF module 704, even when the radio system is adapted for high power applications such as, for example, cellular handset applications. Once upconverted, the RF modulated signal is band-pass filtered and then amplified by the PA 726 to generate an amplified RF modulated signal, which is radiated by the antenna 706 to a remote receiver (not shown in the drawing). The power control circuit 724 controls the output power of the PA, as commanded by digital control signals received from the BB IC 702.

When the radio system 700 is configured to receive, the transmit/receive switch 728 is in a position that connects the antenna 706 to the input of the LNA 730. Information bearing RF receive carrier signals received by the antenna 706 from a remote transmitter (not shown in the drawing) is first amplified by the LNA 730 and band-pass filtered to generate filtered and amplified RF receive carrier signals. The filtered and amplified RF receive carrier signals are then downconverted to baseband by the RF dowconverter 722, amplified, and finally converted to received I and Q digital baseband signals. The I and Q digital baseband signals are communicated over the digital interface 718 to the BB IC 402, where the DSP 708 and other digital processing circuitry in the BB IC 402 operate to extract digital messages encoded in the received I and Q digital baseband signals.

The radio system 700 in FIG. 7 is just one of several possible ways in which a quadrature-based radio system may be implemented. The actual digital-analog boundary between the BB IC 402 and RF module 404 may be different in other implementations. For example, while the RF upconverter 720 and RF downconverter 722 in the embodiment of the invention shown in FIG. 7 are implemented using RF analog components, some or all of the upconversion and downconversion circuitry, including or not including the RF oscillator sources for the conversion circuitry, may be digitally implemented and included within the BB IC 702, rather than being formed on the RF module 704. For example, according to one alternative embodiment of the invention, the mixers and oscillators of the radio system's upconversion and downconversion circuitry comprise digital mixers and digitally controlled oscillators that are integrated in the BB IC 402. Common among the various possible implementations, however, is the aspect of the invention of partitioning the radio system along an analog-digital boundary.

Those of ordinary skill in the art will also appreciate and understand that, while the radio systems 400 and 700 shown and described in FIGS. 4 and 7 employ direct conversion (or “homodyne”) techniques, the spirit and scope of the invention extends to radio systems that alternatively employ intermediate frequency upconversion and downconversion stages, such as those used in superheterodyne type radio systems, for example. These intermediate frequency analog components would be included on the RF module 404, while still maintaining an all-digital BB IC and a split digital-analog radio system.

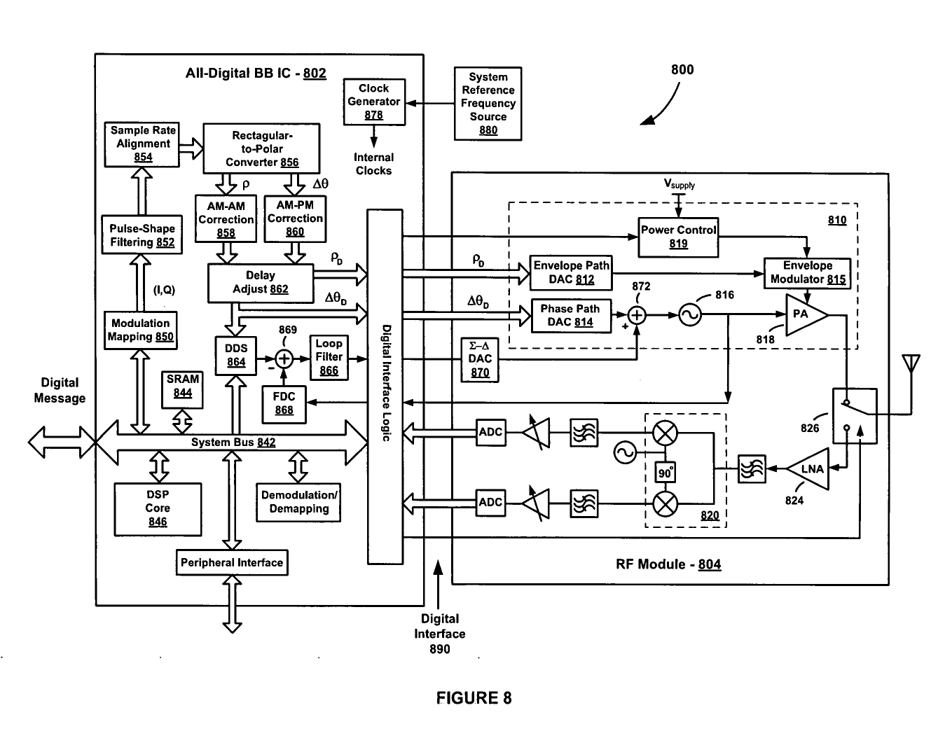

As alluded to above, the split analog-digital radio system aspect of the present invention is also applicable in non-quadrature-based radio system architectures. FIG. 8 is drawing, for example, of a radio system 800 that includes a polar modulator 810 and that is partitioned along an analog-digital boundary formed between an all-digital BB IC 802 and a separate, mostly-all analog RF module 804, according to another embodiment of the present invention.

The RF module 804 includes the baseband analog and RF analog components of the radio system 800, while most of the digital components of the system 800 are configured in the all-digital BB IC 802. The primary components on the RF module 804 include a polar modulator 810, an RF downconverter 820, an LNA 824, and a transmit/receive switch 826. The LNA 824 and RF downconverter 820 operate similar to the LNA 730 and 722 of the radio system 700 in FIG. 7, so will not be described again here. Operation of the polar modulator 810 is described below, following a description of the various functional blocks in the all-digital BB IC 802.

The all-digital BB IC 802 of the radio system 800 includes a system bus 842, over which digital data, address and control signals are communicated to and among various digital components in the BB IC 802. A clock generator 878 is included in the BB IC 802 to generate the internal clocks needed to sample and clock the digital signals in the BB IC 802. The clock generator 878 generates the internal clocks based on an external system reference frequency source 880. Some of the blocks in the BB IC 802, such as the SRAM 844, for example, are implemented in hardware. The other blocks may be implemented in firmware, software, hardware or any combination of firmware, software and hardware, as will be appreciated and understood by those of ordinary skill in the art.

The principal operations of the digital modulation process performed in the BB IC 402 include a modulation mapping 850 process, a pulse-shape filtering process 852, a rectangular-to-polar conversion process 856, amplitude-to-amplitude modulation (AM-AM) and amplitude-to-phase modulation (AM-PM) correction processes 858 and 860, and a delay adjust 862 process. The modulation mapping process 850 groups bits of a digital message received on the system bus 842 into I and Q sequences of information bearing symbols, according to a predetermined digital modulation scheme. Pulse-shape filtering 852 is then applied to the I and Q sequences of information bearing symbols to reduce the modulation bandwidth of the sequences of symbols. To account for any discrepancy that might arise between an available oversample clock rate and a required symbol rate, the pulse-shaped sequences of symbols are subjected to a sample rate alignment process 854. The rate-converted I and Q pulse-shaped sequences of symbols resulting from the sample rate alignment process 854 are then converted to polar amplitude and phase modulation signals, p and 0, by a rectangular-to-polar conversion process (e.g., by a Coordinate Rotation Digital Computer (CORDIC) algorithm) 856. The phase modulation signal, θ, is actually a signal containing the phase differences between sample clocks and, therefore, has units of frequency (i.e., dθ/dt). For this reason, the phase modulation signal will be referred to as the “phase difference modulation signal, Δθ”, in the description that follows.

Following the rectangular-to-polar conversion process 856, the AM-AM and amplitude-to-phase AM-PM correction processes 858 and 860 are performed on the amplitude and phase difference modulation signals, ρ and Δθ. The AM-AM and AM-PM correction processes 858 and 860 involve pre-distorting the amplitude modulation and phase difference modulation signals based on knowledge of how the radio system's PA 818 will distort the signals when eventually amplified by the PA 818. The amplitude and phase distortions caused by the PA 818 vary depending on the amplitude of the signals applied to the PA 818, and on the imperfections of the particular PA 818 used. To account for these dependencies, and to ensure that the appropriate amounts of amplitude and phase pre-distortions are applied to the amplitude modulation and phase difference modulation signals, ρ and θ, AM-AM and AM-PM pre-distortion tables containing various amplitude dependent pre-distortion factors derived from a predetermined characterization of the PA 818 are stored in one or more look-up table (LUTs) in the BB IC 802.

Following the AM-AM and AM-PM correction processes 858 and 860, the delay adjustment process 862 is applied to the AM-AM and AM-PM corrected amplitude modulation and phase difference modulation signals. The delay adjustment process 862 accounts for the difference in delays of signals communicated along the amplitude and phase difference paths of the polar modulator 810. Finally, the AM-AM and AM-PM corrected and delay adjusted amplitude and phase difference modulation signals, ρ_{D} and Δθ_{D}, are made available to the polar modulator 810 on the RF module 804, via the digital interface 890.

The polar modulator 810 comprises an envelope path DAC 812 and envelope modulator 815 configured within an amplitude path of the polar modulator 810; a phase path DAC 814 and controlled oscillator 816 configured within a phase path of the modulator 810; a PA 818; and a power control circuit 819. According to one embodiment of the invention the controlled oscillator 816 comprises an LFO, similar one of the LFOs described above in FIGS. 5 an 6. Implementing the controlled oscillator 816 as an LFO affords the ability to co-locate the oscillator 816 with the PA 818 (e.g., within 1 cm of each other), even in applications where the radio system is adapted for use in a high power application, such as, for example, in a cellular handset.

The controlled oscillator 816, PA 818, other components of the polar modulator 810, and/or other components on the RF module 804 may be formed in a single IC chip, in multiple IC chips or formed from a mixture of IC chips and discrete analog components. According to one exemplary embodiment of the invention, the controlled oscillator 816 and other analog portions of the radio system's upconversion and downconversion circuitry comprise an integrated circuit formed from a silicon-based manufacturing process, and the PA 818 comprises a second IC formed from a compound-semiconductor-based manufacturing process such as GaAs. The first and second ICs are co-located (e.g. within 1 cm of each other) on the RF module 804.

In the amplitude path of the polar modulator 810, the digital AM-AM corrected and delay adjusted amplitude modulation signal, ρ_{D}, is coupled to the envelope path DAC 812, via the digital interface 890. The envelope path DAC 812 coverts the digital amplitude modulation signal, ρ_{D}, into an analog amplitude modulation signal. The envelope modulator 815 operates to modulate a power supply voltage provided by the power control circuit 819, according to variations in amplitude of the analog amplitude modulation signal, thereby generating an amplitude modulated power supply signal. Finally, the amplitude modulated power supply signal is coupled to a power setting input of the PA 818.

In the phase path of the polar modulator 810, the digital AM-PM corrected and delay adjusted phase difference modulation signal, Δθ_{D}, from the BB IC 802 is coupled to the phase path DAC 814, via the digital interface 890. The phase path DAC 814 converts the phase difference modulation signal, Δθ_{D}, into an analog phase difference modulation signal. The analog phase difference modulation signal is used to modulate an RF transmit carrier generated by the controlled oscillator 816. In other words, the controlled oscillator 816 generates an RF phase modulated signal according to phase difference variations in the analog phase difference modulation signal. As will be explained below, an error signal may also be added to the analog phase modulation signal, to correct for differences in actual and desired output oscillator output frequencies. The RF phase modulated signal is coupled to an RF input of the PA 818. The PA 818 is configured so that it is driven into heavy compression, acting in a switch-mode configuration while the amplitude modulated power supply signal from the envelope modulator 815 is applied to the power setting input of the PA 818. When configured in this manner, the output power of the PA 818 is proportional to the amplitude of the amplitude modulated power supply signal.

To provide accurate control and stability of the controlled oscillator 816 output frequency, the controlled oscillator 816 is configured within a phase-locked loop (PLL) or a frequency-locked loop (FLL). With reference to FIG. 8, the FLL is used, and comprises a direct digital synthesizer (DDS) 864, digital loop filter 866, frequency-to-digital converter (FDC) 868, first summer 869, sigma-delta DAC (or “Σ-Δ” DAC) 870, second summer 872, and the controlled oscillator 816. The DDS 864, digital loop filter 866, FDC 868 and first summer 869 are digital circuit elements that are integrated in the all-digital BB IC 802. The Σ-Δ DAC 870, second summer 872, and controlled oscillator 816 are formed on the RF module 804.

The DDS 864 is operable to generate a first digital stream of bits having a pulse density representing a desired output frequency of the controlled oscillator 816. The desired output frequency and representative first digital stream of bits is formed based on a digital frequency constant received by the DDS 864 over the system bus 842 and on the value of the phase difference modulation signal, Δθ_{D}, received from the delay adjust process 862. The frequency constant represents the center frequency of a particular channel at which the radio system 800 is to transmit. The FDC 868 in the feedback loop of the FLL operates to digitize the output of the controlled oscillator 816, thereby generating a second digital stream of bits having a pulse density representing the actual output frequency of the controlled oscillator 816. The first and second digital streams of bits are subtracted at the first summer 869 and then filtered by the loop filter 866 to generate a digital error signal. The digital error signal is converted to an analog error signal on the RF module 804 by the Σ-Δ DAC 870. The analog error signal is then applied to the second summer 872 in the phase path of the polar modulator 810. Accordingly, if the controlled oscillator 816 is operating at the desired frequency, the difference in average pulse densities in the first and second digital streams of bits will result in zero error. However, if the average pulse densities differ, an error signal is produced and added to the phase difference modulation signal, Δθ_{D}, at the second summer 872. Adding the error signal to the phase difference modulation signal, Δθ_{D}, changes the control signal applied to the controlled oscillator 816 in a manner that directs the output frequency of the controlled oscillator 816 toward the desired output frequency. Further details of FLLs and polar modulators similar to the FLL and polar modulator in FIG. 8 may be found in U.S. Pat. Nos. 5,952,895, 6,094,101, 6,219,394 and 6,269,135, and W. B. Sander, “Polar Modulator for Multi-mode Cell Phones” Custom Integrated Circuits Conference, 2003, Proceedings of the IEEE 2003, pp 439-445, Sep. 21-24, 2003, all of which are hereby incorporated into this disclosure by reference.

Although various specific and exemplary embodiments of the invention have been described in detail, it should be understood that various changes, substitutions and alternations can be made without departing from the spirit and scope of the inventions defined by the appended claims.

What is claimed is:

1. A radio system, comprising:
a baseband integrated circuit (BB IC) configured to receive digital messages and generate modulation signals therefrom; and
a radio frequency (RF) module configured to receive the modulation signals from the BB IC, said RF module including: a controlled oscillator configured to generate an RF transmit carrier signal, an RF upconverter configured to generate RF modulated signals from the RF transmit carrier signal and information contained in said modulation signals, and a power amplifier (PA) configured to amplify the RF modulated signals.

2. The radio system of claim 1 wherein the BB IC comprises an all-digital BB IC containing only digital circuitry.

3. The radio system of claim 1, further comprising an all-digital interface configured between the BB IC and the RF module.

4. The radio system of claim 1 wherein said controlled oscillator comprises a low-field oscillator (LFO).

5. The radio system of claim 4 wherein said LFO is co-located with said PA on said RF module.

6. The radio system of claim 1 wherein the BB IC and the RF module are adapted for use in a cellular communications device.

7. The radio system of claim 1 wherein said RF module further comprises an RF receiver front end.

8. A radio system, comprising:
a baseband integrated circuit (BB IC) configured to receive a digital message and generate amplitude modulation signals and phase difference modulation signals therefrom; and
a radio frequency (RF) module comprising a polar modulator including an envelope path having an envelope modulator configured to generate amplitude modulated power supply signals based on amplitude information in said amplitude modulation signals, a phase path having a controlled oscillator configured to generate RF modulated signals based on phase difference information contained in said phase difference modulation signals, and a power amplifier configured to amplify said RF modulated signals according to variations in amplitude of said amplitude modulated power supply signals.

9. The radio system of claim 8 wherein the BB IC comprises an all-digital BB IC containing only digital circuitry.

10. The radio system of claim 8, further comprising an all-digital interface configured between the BB IC and the RF module.

11. The radio system of claim 8 wherein said controlled oscillator comprises a low-field oscillator (LFO).

12. The radio system of claim 11 wherein said LFO is co-located with said PA on said RF module.

13. The radio system of claim 8 wherein said RF module further comprises an RF receiver front end.

14. The radio system of claim 8 wherein said BB IC and said RF module are adapted for use in a cellular communications device.

15. The radio system of claim 8 wherein said controlled oscillator is configured within a frequency control loop formed partly on said BB IC and partly on said RF module.

16. In a radio system comprised of a baseband integrated circuit (BB IC), a radio frequency (RF) module, and an antenna, a method of generating a radio frequency (RF) modulated signal, comprising:
in the BB IC, generating an information bearing digital modulation signal from a digital message;
converting the information bearing digital modulation signal to an information bearing analog modulation signal;
on the RF module, upconverting the information bearing analog modulation signal to RF to generate an RF modulated signal;
on the RF module, amplifying the RF modulated signal to generate an amplified RF modulated signal; and
radiating said amplified RF modulated signal by said antenna to a remote receiver.

17. The method of claim 16 wherein converting the information bearing digital modulation signal to an information bearing analog modulation signal comprises:
communicating the information bearing digital modulation signal over an all-digital interface to conversion circuitry on said RF module; and
converting the information bearing digital modulation signal to the information bearing analog modulation signal using the conversion circuitry.

18. The method of claim 16 wherein upconverting the information bearing analog modulation signal to RF to generate the RF modulated signal and amplifying the RF modulated signal to generate the amplified RF modulated signal are both performed by circuitry configured on said RF module.

19. The method of claim 18 wherein said circuitry configured on said RF module comprises a polar modulator.

20. The method of claim 16 wherein upconverting the information bearing analog modulation signal to RF to generate the RF modulated signal includes generating an RF carrier signal from a low-field oscillator (LFO) configured on said RF module.

21. A radio system, comprising:
means for generating digital modulation signals;
means for upconverting information contained in said digital modulation signals to radio frequency, thereby forming RF modulated signals;
means for amplifying said RF modulated signals to generate amplified RF modulated signals; and
means for radiating said amplified RF modulated signals over the air to a remote receiver,
wherein said means for generating digital modulation signals is configured within a digital baseband integrated circuit and said means for amplifying and at least a portion of said means for upconverting are configured on a common RF module.

22. The radio system of claim 21 wherein said means for upconverting and means for amplifying comprise components of a polar modulator.

23. The radio system of claim 21 wherein said means for upconverting information contained in said digital modulation signals to radio frequency comprises a low-field oscillator (LFO).

24. The radio system of claim 23 wherein said LFO is co-located with said means for amplifying on said common RF module.

25. The radio system of claim 21 wherein said means for generating digital modulation signals, said means for upconverting information and said means for amplifying are adapted for use in a cellular communications device.
